(19) United States
(12) Patent Application Publication
(10) Pub. No.: US 2018/0375265 A1
(43) Pub. Date: Dec. 27, 2018

(54) SOCKET ADAPTER

(71) Applicant: Q2Power AG, Ruggell (LI)

(72) Inventor: Thomas Junker, Solothurn (CH)

(21) Appl. No.: 16/062,327

(22) PCT Filed: Dec. 14, 2016
(86) PCT No.: PCT/CH2016/000154

§ 371 Date: Jun. 14, 2018

(30) Foreign Application Priority Data
Dec. 15, 2015 (CH) CH01840/15

(51) Int. Cl. H01R 13/713; H01R 13/66; H01R 31/06

(52) U.S. Cl. CPC H01R 13/713; H01R 2103/00; H01R 31/065; H01R 13/6683

(57) ABSTRACT

The invention relates to an electrical socket adapter (11) as connecting piece for various plug systems, with a housing, a plug (13) provided on the housing, plug receptacles (19) provided on the housing for receiving plugs according to different standards, and a switch (25, 26) which switches the electrical contact between the plug (13) and the plug receptacles (19). The switch (25, 26) can close and interrupt a circuit which is to be switched and in which the socket adapter (11) can be installed. The switch is implemented by a relay (25, 26).

### CROSS-REFERENCE TO RELATED APPLICATIONS

This US non-provisional patent application is a national stage entry from PCT Application No. PCT/CH2016/000154 filed on Dec. 14, 2016, titled: “STECKDOSENADAPTER (SOCKET ADAPTER)”, pending, which in turn claims benefit and priority to Swiss Patent Application No. 01840/15 filed on Dec. 15, 2015, titled: “STECKDOSENADAPTER (SOCKET ADAPTER)”, expired, the contents of both of which are incorporated by reference as if fully set forth herein and for all purposes.

### BACKGROUND OF THE INVENTION

### Field of the Invention

The invention relates to an electrical socket adapter according to the preamble of Claim 18 and to a method for using an electrical socket adapter according to the preamble of Claim 33.

### Description of Related Art

From the prior art, all sorts of socket adapters are known, which are used primarily to overcome the differences between different plug systems. For safety reasons, the electrical connection between the receptacles of the socket adapter, into which different plugs can be inserted, and the plug can be interrupted by providing a mechanical switch. Thereby, the plug is only in connection with one of the plug receptacles, and the remaining plug receptacles are current-free. For example, solutions are proposed in which the plug can be turned relative to the adapter housing, and thereby the electrical connection with one of the plug receptacles can be established.

However, it should be considered disadvantageous that the switch is operated by the user of the socket adapter and that consequently incorrect applications and operations cannot be ruled out.

In WO 2007/098758, a touch-safe light bulb socket is disclosed. The main circuit, to which a light bulb which can be screwed into the light bulb socket can be connected, is connected by an auxiliary circuit to a relay. On the socket, metal detectors are arranged, by means of which a voltage is generated in the auxiliary circuit if a light bulb is screwed into the socket. If current flows through the auxiliary circuit, the relay closes the main circuit and the light bulb is supplied with electrical current. If a light bulb with a base having a metal outer thread is screwed into the light bulb socket, electrical contacts arranged in the socket are current carrying, and the socket is in electrical connection with said contacts. On the other hand, if no light bulb is screwed into the socket, then the main circuit and the contacts are switched to be current-free via the relay. However, uses for a socket adapter are not disclosed or suggested in this document.

### SUMMARY OF THE INVENTION

The disadvantages of the described prior art result in the problem which the present invention aims to solve, namely the development of a socket adapter according to the preamble, which reliably prevents incorrect operation and increases user safety. In addition, the usability of two-pin socket adapters is to be broadened.

In a known manner, the switch can be implemented by a relay. This has the advantage that the load circuit to be switched cannot be switched by a user, but instead can be switched automatically by a control circuit. Incorrect use is therefore ruled out. An additional advantage is that conditions and limit values can be defined, in terms of when the relay closes the circuit and when it interrupts it. Conceivable conditions are, for example, a defined current intensity or a defined temperature.

According to the invention, the aim is achieved in a socket adapter according to the preamble of claim 1 in that at least one plug receptacle comprises a plug-in opening for receiving a protective conductor pin, and the plug-in opening is in connection with a metal detection, wherein, in the case of detection of a metal in the plug-in opening, the circuit is interrupted by the relay. Thereby, a 2-pin UK plug (standard BS 1363), which usually has formed a dummy of a protective conductor pin, can be used with a 2-pin socket adapter. However, this can lead to a violation of the national safety requirements, since the use of 2-pin socket adapters with 3-pin plugs may be prohibited. In order to avoid violation of safety requirements, the material of the protective conductor pin of the plug is detected in the socket adapter. A UK plug therefore receives current exclusively when it has a dummy of the protective conductor pin, which is typically made of plastic. A UK plug with a protective conductor pin made of metal leads to an interruption of the load circuit when it is plugged into the socket adapter.

In contrast to the prior art, in which the circuit is closed via a metal detector when a metal is detected in the lamp socket, the invention follows an entirely different concept. Surprisingly, a relay can be used in a 2-pin electrical socket adapter, in order to be able to also use a 2-pin UK plug with ground pin dummy, without violation of national safety requirements. The insertion of a 3-pin UK plug into the 2-pin socket adapter is therefore necessarily possible. The metal detector is not used in the usual way, so that the load circuit is closed when there is detection of a metal, instead a plugged-in 3-pin UK plug is prevented from receiving current.

Therefore, it is preferable if the at least one plug receptacle is suitable for receiving a plug according to the standard BS 1363, standard which defines a British plug. Since a UK plug according to the standard BS 1363 comprises either a ground pin or a ground pin dummy, the plug receptacle in any case must comprise a plug-in opening for receiving a protective conductor pin.

Advantageously, the socket adapter comprises a plug power supply which supplies a DC voltage, preferably of 5 V. Thereby, on the socket adapter, a USB socket can be provided in order to supply devices with 5 V DC voltage.

In a particularly preferred embodiment, the plug power supply supplies the control circuit of the relay. The control current is therefore always available and does not have to be supplied by an external energy source, for example, a battery. Thus, the relay can also switch larger loads with a low voltage source.

It has been found to be advantageous if the relay acts as an electrical fuse and/or as a thermal cutoff. Fuses which burn out when tripped and have to be replaced with new fuses are obsolete in the case of the present socket adapter. The adapter only needs to be isolated from the grid when the relay is tripped, so that it is again usable.

In a preferred embodiment, the socket adapter comprises a current measurement, and the circuit can be interrupted by the relay if the power consumption of the socket adapter exceeds a limit value. As a result, overloads in the load circuit are reliably prevented.

The invention is preferably also characterized in that the socket adapter comprises a temperature measurement, and the circuit can be interrupted by the relay if the temperature of the socket adapter exceeds a limit value. Thereby, the adapter is not only secured against excessive current loads but also against excessive temperatures.

Advantageously, the limit values for current intensity and/or temperature are stored in a microchip. By means of appropriate software, the limit values can be read into the microchip. As limit values, for example, 10 amperes for the current load and a temperature difference of 45 K can be stored on the microchip. The microchip can be supplied with current via the low voltage source, represented by the plug power supply, which is present in any case.

For galvanic isolation between the load circuit and the control circuit, an iron ring is provided between the circuits.

In a preferred embodiment, the relay is a semiconductor relay, in particular a triac. Since the triac is an electronic component, it is not susceptible to failure. In addition, triacs are very suitable for switching alternating current and have a compact design.

It is particularly preferable if the triac is switched by a phototriac. A phototriac enables a galvanic isolation of the load circuit from the control circuit. Thereby, the alternating current load circuit is actuated in a hazard free manner with a low voltage source of 5 V.

Preferably, the plug is connected in an electrically conductive manner to the plug receptacles by a neutral conductor and a phase conductor, and the socket adapter has no protective conductor. The socket adapter therefore has only 2 pins and is used for electronic and electrical devices that do not need to be grounded.

Advantageously, by means of the relay, at least the phase conductor can be switched. If the phase conductor and the neutral conductor are switched by the relay, then the socket adapter is of larger design. However, the protection is improved if the two conductors are switched by the relay.

Another aspect of the invention relates to the method for using an electrical socket adapter with a 2-pin plug for receiving a 3-pin plug of a consumer in a plug receptacle of the socket adapter. According to the invention, the electrical connection between plug receptacle and plug is established if the protective conductor pin is not electrically conductive, and the electrical connection is interrupted if the protective conductor pin is electrically conductive. As a result, a 2-pin UK plug with a protective conductor pin dummy can be used with a 2-pin socket adapter, without violation of the safety requirements.

Additional advantages and features result from the following description of two embodiment examples of the invention in reference to the diagrammatic representations. In a not true-to-scale representation:

### BRIEF DESCRIPTION OF THE DRAWINGS

FIG. 1 shows: a circuit diagram of a first embodiment of an electrical socket adapter, and

FIG. 2 shows: a circuit diagram of a second embodiment of the electrical socket adapter.

### DETAILED DESCRIPTION

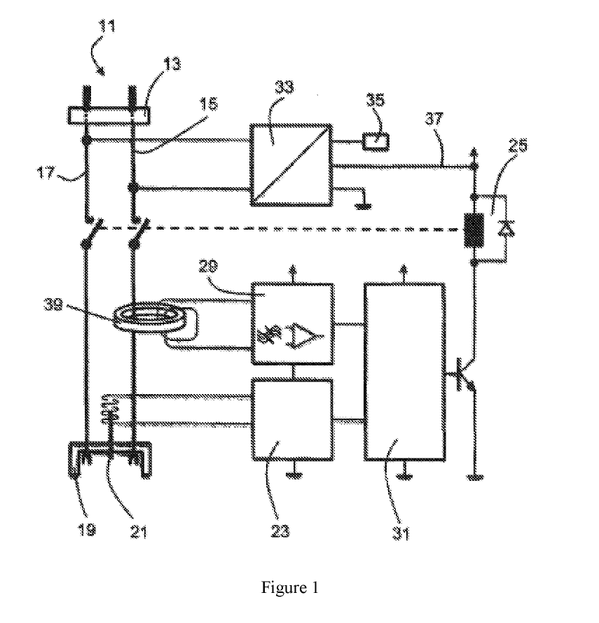

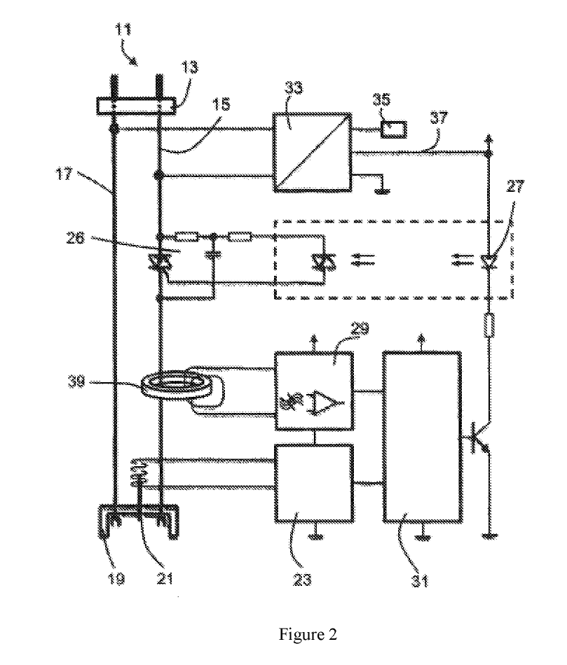

In FIGS. 1 and 2, a first and a second embodiment of an electrical socket adapter are depicted, which overall bear the reference numeral 11. The socket adapter 11 comprises a plug 13, for example, a plug according to the Swiss standard or another standard. The socket adapter 11 comprises a phase conductor 15 and a neutral conductor 17. The conductors 15, 17 are connected in an electrically conductive manner to at least one plug receptacle 19. The plug receptacles 19 are used for receiving plugs according to different standards, so that in a country in which only the plug 13 fits plugs of other standards can also be used. Such electrical socket adapters are also referred to as travel adapters or travel plugs. According to the legal requirements in some countries, socket adapters that lack a third pin, that is to say a protective conductor, should not allow plugs with three pins to be plugged in.

Plugs according to the UK standard (BS 1363) always have three pins. If no protective conductor is necessary to operate the electric device, then a UK plug is provided with a protective conductor pin dummy made of an electrically nonconductive material. This results in the problem that 2-pin UK plugs cannot be used with 2-pin socket adapters, since, for safety reasons, 2-pin socket adapters should not have a plug-in opening for a protective conductor pin dummy.

The present socket adapter solves this problem in that it provides a plug-in opening 21 for protective conductor pins or dummies thereof. In order to comply with the legal requirements of a 2-pin adapter, the adapter 11 is equipped with a metal detection circuit 23. If an electrically conductive metal pin is plugged into the plug-in opening 21, then at least the phase conductor 15 and optionally additionally the neutral conductor 17 are interrupted, and the load circuit or the main circuit thus no longer carries a current. However, if a nonconductive pin or no pin is inserted into the plug-in opening 21, then the load circuit remains closed, in that neither the phase conductor 15 nor the neutral conductor 17 is interrupted.

The switching function for switching the load circuit is performed by a relay 25, for example, an electromechanical relay or a semiconductor relay, for example, a triac 26. Preferably, the triac 26 is itself switched by a phototriac 27, in order to be able to galvanically isolate the triac. In addition to the on/off switching of the load circuit, the switching elements 25, 26 can also perform other switching tasks depending on the material of a protective conductor pin. Thus, the adapter 11 can comprise a current measurement 29. If the current flowing in the load circuit exceeds a limit value, then the load circuit is interrupted by the switching elements 25, 26. The adapter 11 can also comprise a temperature sensor. If the temperature of the adapter 11 exceeds a limit value, then the load circuit is also interrupted by the switching elements 25, 26. The limit values for current and temperature are stored in a microchip 31 and can be loaded by means of software. A limit value for the current measurement is, for example, 16 A. For the temperature limit, for example, a temperature difference of 45 K can be predetermined.

The relay 25 and the triac 26 can replace electrical fuses or thermal cutoffs. Such fuses burn out when tripped and have to be replaced. The switching elements 25, 26, on the other hand, simply close the conductors 15, 17 again in that the adapter 11 is isolated from the grid and plugged in again after a certain time.

The socket adapter 11 comprises a plug power supply 33 which converts the connected alternating current into a direct current of preferably 5 V. The direct current can be collected, for example, at a USB socket 35. The plug power supply 33 makes the control circuit 37 available for the switching elements 25, 26.

In order to galvanically isolate the circuit which measures the current of the load circuit from the measurement circuit 41 or control circuit 37, an iron ring 39 is provided.

The socket adapter 11 makes it possible to use a 2-pin UK plug with a protective conductor pin dummy in other countries, without violation of the local safety laws for 2-pin plug receptacles. The socket adapter has the additional added value that the relay 25 or the semiconductor relay provided, in particular a triac 26, can be used for monitoring the flowing current and the temperature of the adapter 11. Consequently, in the adapter 11, fuses that burn out can be dispensed with.

### KEY

11 Electrical socket adapter
13 Plug
15 Phase conductor
17 Neutral conductor
19 Plug receptacle
21 Plug-in opening
23 Metal detection circuit
25 Relay
26 Triac
27 Phototriac
29 Current measurement
31 Microchip
33 Plug power supply
35 USB socket
37 Control circuit
39 Iron ring

1-17. (canceled)

18. An electrical socket adapter (11) as connecting piece for various plug systems, comprising:
a housing;
a plug (13) provided on the housing;
plug receptacles (19) provided on the housing for receiving plugs according to different standards;
a relay (25, 26) which switches an electrical contact between the plug (13) and the plug receptacles (19) and as a result can close and interrupt a circuit which is to be switched and in which the socket adapter (11) can be installed; and
wherein at least one plug receptacle (19) further comprises a plug-in opening (21) for receiving a protective conductor pin, and the plug-in opening (21) is in connection with a metal detection (23), such that where metal is detected in the plug-in opening (21), the circuit is interrupted by the relay (25, 26).

19. The socket adapter according to claim 18, further comprising the at least one plug receptacle (19) is suitable for receiving a plug according to the standard BS 1363, standard which defines a British plug.

20. The socket adapter according to claim 18, wherein the socket adapter (11) further comprises a plug power supply (33) which supplies a DC voltage.

21. The socket adapter according to claim 20, wherein the DC voltage comprises 5 V.

22. The socket adapter according to claim 20, wherein the plug power supply (33) supplies a control circuit (37) of the relay (25, 26).

23. The socket adapter according to claim 18, wherein the relay (25, 26) acts as an electrical fuse and/or as a thermal cutoff.

24. The socket adapter according to claim 18, wherein the socket adapter (11) further comprises a current measurement (29), and the circuit can be interrupted by the relay (25, 26) if the measured current of the socket adapter (11) exceeds a limit value.

25. The socket adapter according to claim 18, wherein the socket adapter (11) further comprises a temperature measurement, and the circuit can be interrupted by the relay (25, 26) if the measured temperature of the socket adapter (11) exceeds a limit value.

26. The socket adapter according to claim 24, wherein the limit value for measured current is stored in a microchip (31).

27. The socket adapter according to claim 25, wherein the limit value for temperature is stored in a microchip (31).

28. The socket adapter according to claim 18, wherein an iron ring (39) is provided for the galvanic isolation of the circuits.

29. The socket adapter according to claim 18, wherein the relay is a semiconductor relay, in particular a triac (26).

30. The socket adapter according to claim 29, wherein the triac (26) is switched by a phototriac (27).

31. The socket adapter according to claim 18, further comprising the plug (13) electrically connected to the plug receptacles (19) by a neutral conductor (17) and a phase conductor (15), and the socket adapter (11) has no protective conductor.

32. The socket adapter according to claim 31, wherein at least the phase conductor (15) can be switched by the relay (25, 26).

33. A method for using an electrical socket adapter (11) with a 2-pin plug (13) for receiving a 3-pin plug of a consumer in a plug receptacle (19) of the socket adapter (11), the method comprising:
establishing an electrical connection between plug receptacle (19) and plug (13) if a protective conductor pin is not electrically conductive; and
interrupting the electrical connection if the protective conductor pin is electrically conductive.

34. The method according to claim 33, further comprising switching the electrical connection by a relay (25, 26).
